(19) United States
(12) Patent Application Publication
(10) Pub. No.: US 2023/0394067 A1
(43) Pub. Date: Dec. 7, 2023

(54) DATA ANALYSIS PROCESSING APPARATUS, DATA ANALYSIS PROCESSING METHOD, AND PROGRAM

(71) Applicant: Nippon Telegraph and Telephone Corporation, Tokyo (JP)

(72) Inventor: Satoru YAGI, Musashino-shi, Tokyo (JP)

(21) Appl. No.: 18/033,462

(22) PCT Filed: Oct. 27, 2020
(86) PCT No.: PCT/JP2020/040214

§ 371 Date: Apr. 24, 2023

(51) Int. Cl. G06F 16/28

(52) U.S. Cl. CPC G06F 16/283; G06F 16/285

(57) ABSTRACT

A data analysis processing device includes a multidimensional database, an OLAP operation execution unit, a multidimensional database management unit, and a time series alignment unit. The multidimensional database accumulates data embodying a real-world event in a multidimensional cube constructed for each subject in association with an identifier of the event. The OLAP operation execution unit executes an online analytical processing (OLAP) operation on the multidimensional cube in response to a request from a client. In the multidimensional cube, the multidimensional database management unit manages data of a time dimension, data of a spatial dimension, data of a plurality of types of intrinsic dimensions, and data representing characteristics of a plurality of types. In a case where there is no timing when the value of dimensional data to be analyzed and/or the value of data representing a characteristic to be analyzed change at the same time, the time series alignment unit processes the data so that the timing exists.

### TECHNICAL FIELD

One aspect of the present invention relates to a data analysis processing device, a data analysis processing method, and a program.

### BACKGROUND ART

Real world events change in time, space, or both. That is, an event may be generated, may disappear, or a state thereof may transition. Data representing events can be mapped to multidimensional cubes in the sense of data analysis techniques. A data analysis processing device executes an online analytical processing (OLAP) operation on the multidimensional cube to analyze data (refer to, for example, Non Patent Literature 1 and Non Patent Literature 2).

The data analysis processing device generates the multidimensional cube by capturing data of a certain period on a time series from an information source. The multidimensional cube is updated by capturing data of a new period on the time series from the information source. Here, the generation and update of the multidimensional cube may be either batch processing or real-time processing. Performing an OLAP operation on the multidimensional cube allows for referencing/aggregating data that configures the multidimensional cube and analyzing the data.

Incidentally, a value of dimensional data to be analyzed and a value of data representing a characteristic to be analyzed may change at the same timing. In this case, by selecting, aggregating, or calculating data at a time point or a period of the timing, data at the same time point/in the same period can be analyzed in association with each other. For example, if there is a timing in units of months/quarters/years at which values of data to be analyzed change at the same time, for example, there is the following analysis method.

(1) Data is selected on a monthly basis, and data of the same month is analyzed in association with a plurality of data pieces.

(2) Data pieces are aggregated on a quarter basis, and aggregated values of the same quarter are analyzed in association with each other among a plurality of data pieces.

(3) A variation range of data is calculated in units of years, and a variation value in the same year is analyzed in association with a plurality of data pieces.

### CITATION LIST

### Non Patent Literature

Non Patent Literature 1: R. Kimball (Author), Fujimoto, Okada, Shimohira, Ito, Obata (Translation): Data Warehouse Tool Kit, Chapter 2, Time Dimension, Nikkei BP (1998) Non Patent Literature 2: Kosuke NAKABASAMI, Hiroyuki KITAGAWA, Shaikh, S., A., Toshiyuki AMAGASA: Query optimization method in StreamOLAP, DBS Japanese Journal, Vol. 14-J, No. 3 (2016)

### SUMMARY OF INVENTION

### Technical Problem

In the conventional data analysis processing device, conditions under which data at the same time point/in the same period can be analyzed in association with each other are limited. That is, only in a case where there is a timing at which a value of dimensional data to be analyzed and/or a value of data representing a characteristic to be analyzed change at the same time, it is only possible to process (select, aggregate, calculate, or the like) the data at the time point/period represented by the timing.

The present invention has been made in view of the above circumstances, and an object of the present invention is to provide a technique capable of relaxing restrictions on analysis and analyzing data at the same time point/in the same period in association with each other.

### Solution to Problem

A data analysis processing device according to an aspect of the present invention includes a multidimensional database, an OLAP operation execution unit, a multidimensional database management unit, and a time series alignment unit. The multidimensional database accumulates data embodying a real-world event in a multidimensional cube constructed for each subject in association with an identifier of the event. The OLAP operation execution unit executes an online analytical processing (OLAP) operation on the multidimensional cube in response to a request from a client. In the multidimensional cube, the multidimensional database management unit manages data of a time dimension, data of a spatial dimension, data of a plurality of types of intrinsic dimensions, and data representing characteristics of a plurality of types. In a case where there is no timing when the value of dimensional data to be analyzed and/or the value of data representing a characteristic to be analyzed change at the same time, the time series alignment unit processes the data so that the timing exists.

### Advantageous Effects of Invention

According to one aspect of the present invention, it is possible to provide a technology capable of relaxing restrictions on analysis and analyzing data at the same time point/in the same period in association with each other.

### BRIEF DESCRIPTION OF DRAWINGS

FIG. 1 is a functional block diagram illustrating an example of a data analysis processing device according to the present invention.

FIG. 2 is a schematic diagram illustrating comparison between a case where there is a timing when a value of dimensional data to be analyzed and/or a value of data representing a characteristic to be analyzed change at the same time and a case where there is no timing.

FIG. 3 is a sequence diagram illustrating an example of processing in a data analysis processing device 10.

FIG. 4 is a flowchart illustrating an example of a processing procedure of a time series alignment unit 17.

FIG. 5 is a flowchart illustrating a processing procedure of the time series alignment unit 17 when the processing type is “time point”.

FIG. 6 is a diagram illustrating an example of “time point” of “set of time points” in FIG. 5.

FIG. 7 is a schematic diagram illustrating an example of a process of processing data such that there is a timing when values of data pieces change at the same time.

FIG. 8 is a schematic diagram illustrating another example of a process of processing data such that there is a timing when values of data pieces change at the same time.

FIG. 9 is a schematic diagram illustrating another example of a process of processing data such that there is a timing when values of data pieces change at the same time.

FIG. 10 is a flowchart illustrating a processing procedure of the time series alignment unit 17 when the processing type is “period”.

FIG. 11 is a diagram illustrating an example of “periods” in a “set of periods”, an example of a “data allocation method” in a “processing method”, and an example of “data selection/aggregation/calculation methods” in the “processing method” in FIG. 10.

FIG. 12 is a schematic diagram illustrating an example of a process of processing data such that there is a timing when values of data pieces change at the same time.

FIG. 13 is a schematic diagram illustrating another example of a process of processing data such that there is a timing when values of data pieces change at the same time.

FIG. 14 is a schematic diagram illustrating another example of a process of processing data such that there is a timing when values of data pieces change at the same time.

FIG. 15 is a block diagram illustrating an example of a hardware configuration of a data analysis processing device according to the present invention.

### DESCRIPTION OF EMBODIMENTS

Hereinafter, embodiments according to the present invention will be described with reference to the drawings.

(Configuration)

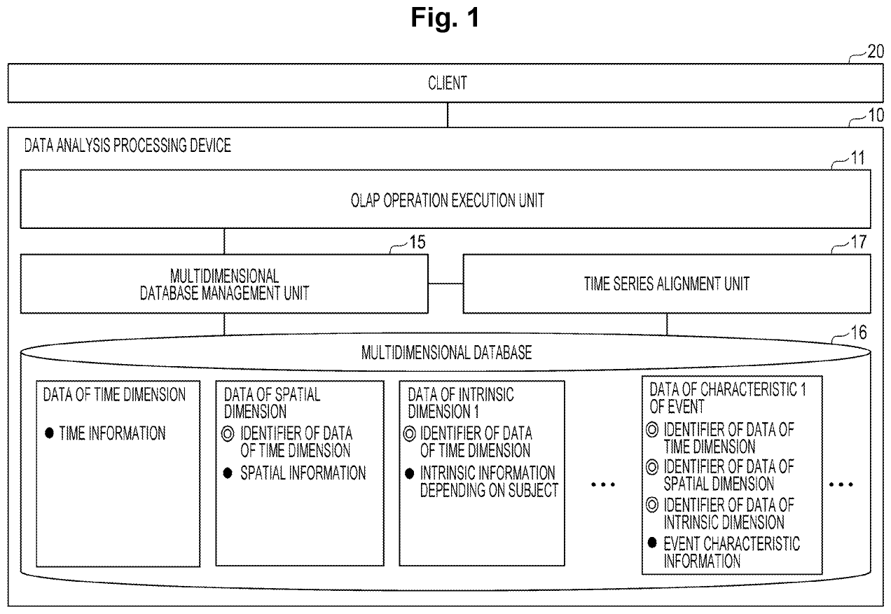

FIG. 1 is a functional block diagram illustrating an example of a data analysis processing device according to the present invention. The data analysis processing device 10 includes an OLAP operation execution unit 11, a multidimensional database management unit 15, a time series alignment unit 17, and a multidimensional database 16.

The multidimensional database 16 accumulates data embodying events in the real world in a multidimensional cube in association with an identifier of an event for identifying an event that is an information source of the data. Multidimensional cubes are constructed for each subject. The accumulated data includes data of a time dimension, data of a spatial dimension, data of a plurality of types of intrinsic dimension, and data representing characteristics of a plurality of types. There are multiple types of intrinsic dimensional data pieces that depend on the subject. Data representing the characteristic is identified by data of a time dimension, a spatial dimension, and an intrinsic dimension. There are multiple types of characteristic data that depend on the subject.

The OLAP operation execution unit 11 executes an OLAP operation to the multidimensional data according to the OLAP operation and the argument received from a client 20. That is, the OLAP operation execution unit 11 instructs the multidimensional database management unit 15 to perform the OLAP operation on the multidimensional data. When receiving the result of the operation on which an instruction is given from the multidimensional database management unit 15, the OLAP operation execution unit 11 transmits the operation result to the client 20.

In the multidimensional cube, the multidimensional database management unit 15 manages data of a time dimension, data of a spatial dimension, data of a plurality of types of intrinsic dimensions, and data representing characteristics of a plurality of types. In addition, the multidimensional database management unit 15 refers to configuration information of the data pieces accumulated in the multidimensional database 16 in accordance with an instruction from the OLAP operation execution unit 11. In a case where there is no timing when the value of dimensional data to be analyzed and/or the value of data representing a characteristic to be analyzed change at the same time, the multidimensional database management unit 15 instructs the time series alignment unit 17 to process the data to be analyzed.

In a case where there is no timing when the value of the dimensional data to be analyzed and/or the value of data representing characteristics to be analyzed change at the same time, the time series alignment unit 17 processes the data such that the timing exists. That is, the time series alignment unit 17 operates on the data configuring the multidimensional cube or the processed data based on the instruction from the multidimensional database management unit 15, and returns the operation result to the multidimensional database management unit 15. The multidimensional database management unit 15 returns the operation result to the OLAP operation execution unit 11.

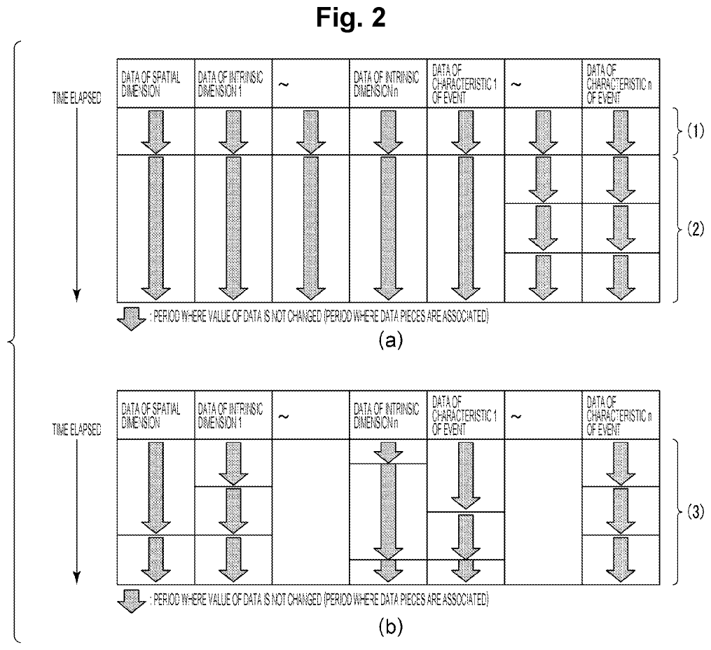

FIG. 2 is a diagram illustrating comparison between a case where there is a timing when a value of dimensional data to be analyzed and/or a value of data representing a characteristic to be analyzed change at the same time and a case where there is no timing.

FIG. 2(a) illustrates an example of a case where there is a timing when a value of dimensional data to be analyzed and/or a value of data representing a characteristic to be analyzed change at the same time. In FIG. 2(a), there is a timing when a period in which the value of the data does not change (a period in which the data is associated) is switched at the same time. This is because the data configuring the multidimensional cube is associated with time points/periods represented by units having a multiple relationship. In this case, for example, by selecting data on a monthly basis, it is possible to associate data on a monthly basis, and it is possible to analyze the associated data on a monthly basis as a target (1). Furthermore, for example, by aggregating data pieces on a quarter basis, aggregated values on a quarter basis can be associated, and the associated aggregated values on a quarter basis can be analyzed as a target (2).

FIG. 2(b) illustrates an example of a case where there is no timing when a value of dimensional data to be analyzed and/or a value of data representing a characteristic to be analyzed change at the same time. In FIG. 2(b), there is no timing when a period in which the value of the data does not change (a period in which the data is associated) is switched at the same time. This is because the data configuring the multidimensional cube is not associated with time points/periods represented by units having a multiple relationship. In this case, since data at the same time point/in the same period cannot be associated as illustrated in FIG. 2(a), the associated data at the same time point/in the same period cannot be analyzed as a target (3).

Therefore, in the embodiment, the time series alignment unit 17 processes the data such that there is a timing when the values of the data pieces to be analyzed change at the same time based on the instruction of the multidimensional database management unit 15. In this way, data pieces at the same time point/in the same period can be associated, and data pieces at the same time point/in the same period can be analyzed as a target.

(Operation)

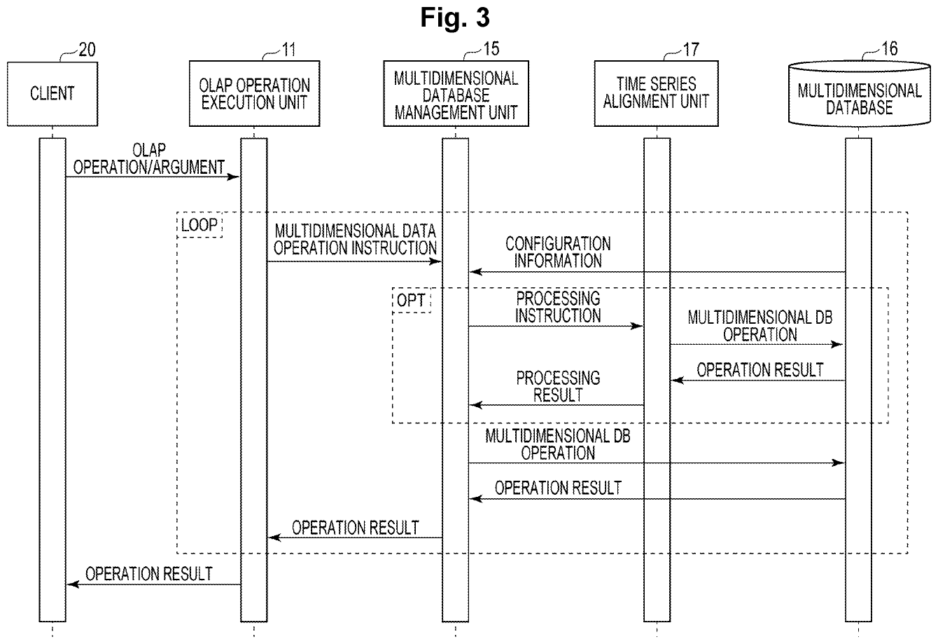

FIG. 3 is a sequence diagram illustrating an example of processing in a data analysis processing device 10. In FIG. 3, the OLAP operation execution unit 11 instructs the multidimensional database management unit 15 to operate the multidimensional data according to the OLAP operation/argument received from the client 20.

The multidimensional database management unit 15 refers to the configuration information of the data configuring the multidimensional cube accumulated in the multidimensional database 16 according to the given operation instruction. At the time, in a case where there is no timing when the value of the dimensional data to be analyzed and/or the value of the data representing a characteristic to be analyzed change at the same time, the multidimensional database management unit 15 instructs the time series alignment unit 17 to process the data to be analyzed (“OPT” enclosed by a broken line in FIG. 3).

In response to an instruction from the multidimensional database management unit 15, the time series alignment unit 17 processes the data such that there is a timing when the values of the data pieces to be analyzed change at the same time, and returns the result to the multidimensional database management unit 15. This makes it possible to associate data pieces at the same time point/in the same period.

The multidimensional database management unit 15 operates data configuring the multidimensional cube or processed data in accordance with an operation instruction from the OLAP operation execution unit 11. Then, the multidimensional database management unit 15 returns an operation result to the OLAP operation execution unit 11.

The OLAP operation execution unit 11 repeats the instruction to the multidimensional database management unit 15 in accordance with the contents of the received OLAP operation and argument (“LOOP” enclosed by a broken line in FIG. 3). At that time, the OLAP operation execution unit 11 uses at least one of an argument an instruction on which is given from the client 20, data configuring another multidimensional cube, or processed data as an argument of the OLAP operation. Then, when the final operation result corresponding to the contents of the OLAP operation and the argument can be acquired, the OLAP operation execution unit 11 returns the operation result of the OLAP operation to the client 20.

The multidimensional database management unit 15 transmits a data processing instruction to the time series alignment unit 17 when receiving the operation of the multidimensional data from the OLAP operation execution unit 11. Furthermore, the multidimensional database management unit 15 can also generate a multidimensional cube in the multidimensional database 16 or transmit a data processing instruction to the time series alignment unit 17 when the generated multidimensional cube is updated.

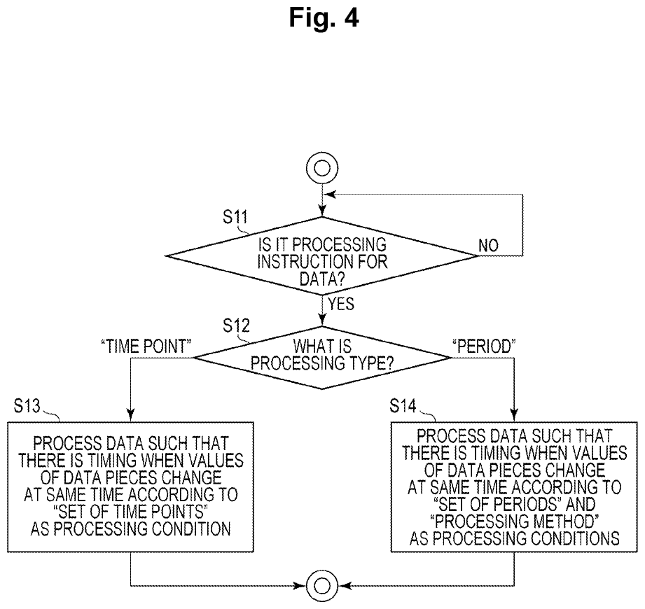

FIG. 4 is a flowchart illustrating an example of a processing procedure of a time series alignment unit 17. In FIG. 4, the time series alignment unit 17 waits for the arrival of a data processing instruction from the multidimensional database management unit 15 (step S11). When receiving the processing instruction, the time series alignment unit 17 processes the data such that there is a timing when the values of the data pieces change at the same time according to the processing type and processing condition on which an instruction is given, and enables data at the same time point/in the same period to be associated (step S12).

In step S12, when the processing type is a “time point”, the time series alignment unit 17 processes the data such that there is a timing when the values of the data pieces change at the same time according to the “set of time points” as the processing condition.

In step S12, when the processing type is a “period”, the time series alignment unit 17 processes the data such that there is a timing when the values of the data pieces change at the same time according to the “set of periods” and the “processing method” as the processing conditions.

As illustrated in FIG. 4, the time series alignment unit 17 processes the data such that there is a timing when the values of the data pieces change at the same time according to the processing instruction of the data, and thus, it is possible to associate the data pieces of the same time point/the same period.

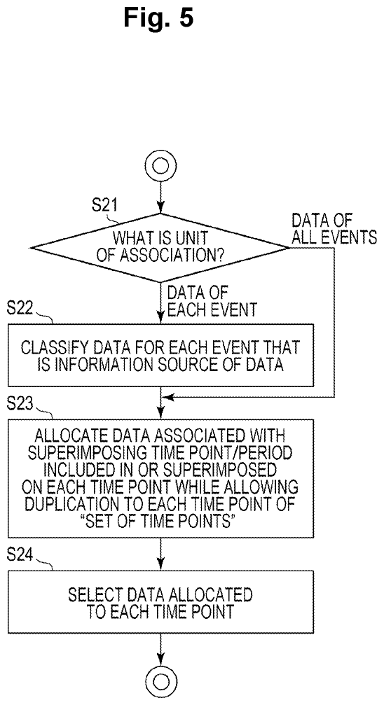

FIG. 5 is a flowchart illustrating a processing procedure of the time series alignment unit 17 when the processing type is “time point”. In FIG. 5, the time series alignment unit 17 determines a unit of association (association) of data pieces at the same time point/in the same period (step S21), and if the unit is data having all events as an information source, the process proceeds to step S23. In step S21, if the unit of association is data in which each event is an information source, the time series alignment unit 17 classifies the data pieces for each event that is an information source of the data (step S22).

Next, the time series alignment unit 17 classifies associated time points/periods of data pieces at each time point of the “set of time points” for data of all events or data of each event (step S23). That is, the time series alignment unit 17 allocates, at each time point, data associated with a time point/period included in or superimposed on each time point while allowing duplication.

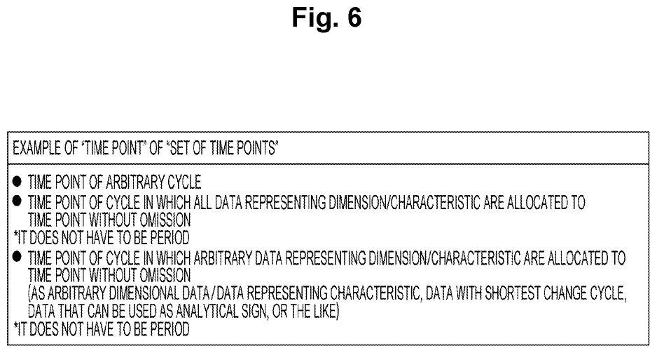

FIG. 6 is a diagram illustrating an example of “time point” of “set of time points” in FIG. 5.

Next, the time series alignment unit 17 selects data allocated at each time point (step S24). At this time, if there is no dimensional data/data representing characteristics of dimensions allocated to a certain time point, the time point can be excluded from the “set of time points”. Alternatively, it is also possible to generate and accumulate a new multidimensional cube from each time point and data allocated to each time point.

According to the above procedure, the time series alignment unit 17 processes the data such that there is a timing when values of the data pieces change at the same time according to the “set of time points” as the processing condition in a case where the processing type is the “time point”.

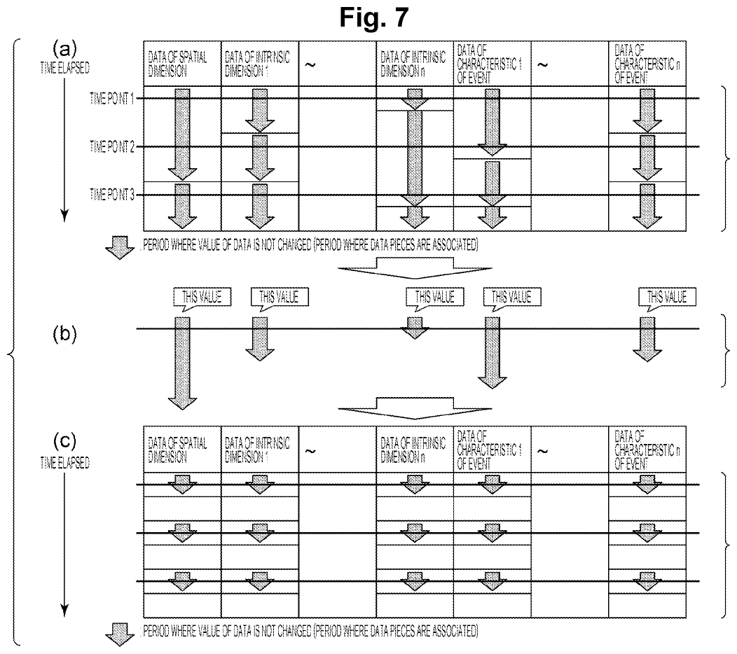

With reference to FIGS. 7 to 9, a process of processing data such that there is timing when the values of the data pieces change at the same time will be described. In FIG. 7, a time point of an arbitrary cycle is illustrated as a “time point” of a “set of time points”. In FIG. 7(a), the time series alignment unit 17 allocates data pieces associated with a time point/period included in or superimposed on each time point to each time point of the “set of time points” while allowing duplication. Here, the “time point” is a time point of an arbitrary cycle.

In FIG. 7(b), the time series alignment unit 17 selects the allocated data. As a result, as illustrated in FIG. 7(c), data processed such that there is a timing when the values of the data pieces change at the same time is obtained.

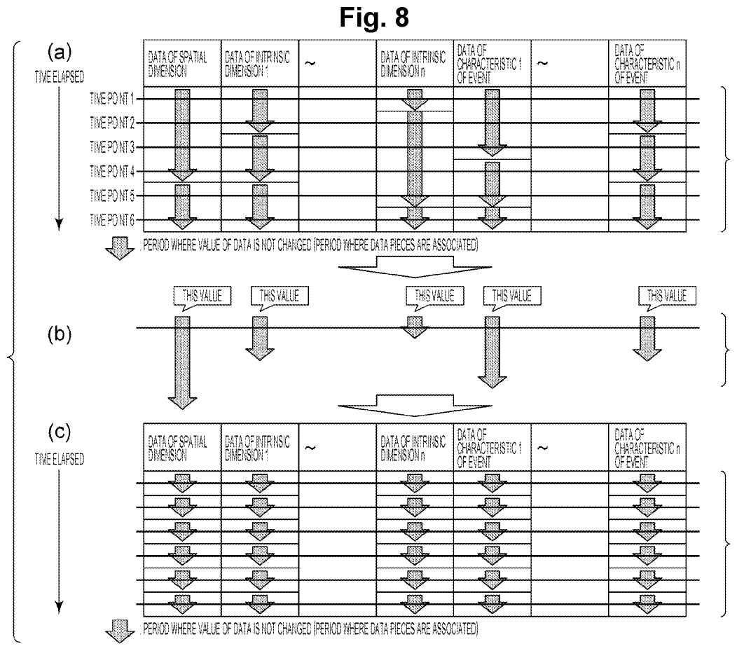

In FIG. 8, as the “time point” of the “set of time points”, the time point of the cycle in which all dimensional data pieces/data pieces representing characteristics are allocated to the time point without omission is illustrated. In FIG. 8(a), the time series alignment unit 17 allocates data pieces associated with a time point/period included in or superimposed on each time point to each time point of the “set of time points” while allowing duplication. Here, the “time point” is a time point of a cycle in which all data pieces are allocated to the time point without omission.

In FIG. 8(b), the time series alignment unit 17 selects the allocated data. As a result, as illustrated in FIG. 8(c), data processed such that there is a timing when the values of the data pieces change at the same time is obtained.

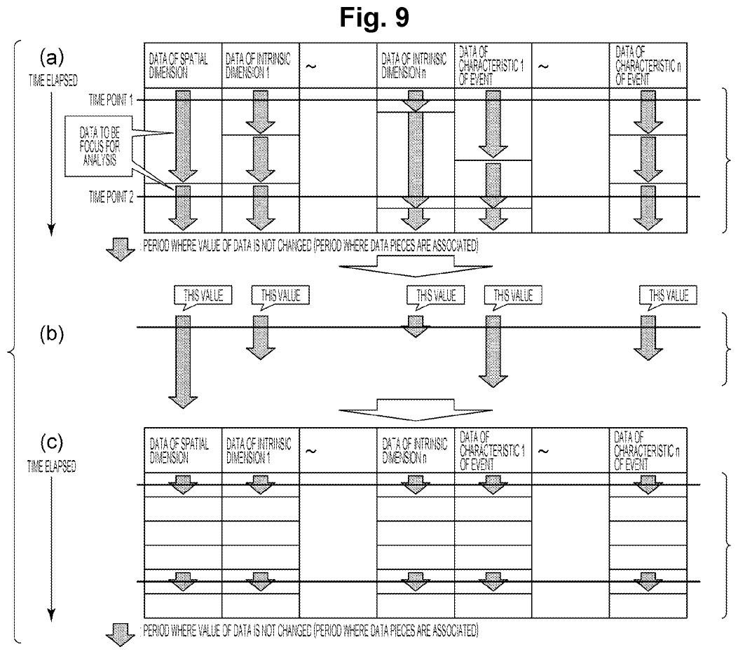

In FIG. 9, as the “time point” of the “set of time points”, the time point of the cycle in which arbitrary dimensional data/data representing a characteristic is allocated to the time point without omission is illustrated. As arbitrary dimensional data/data representing a characteristic, there are options of data having the shortest change cycle, data to be a focus for analysis, and the like. Here, an example in which data to be a focus for analysis is selected is illustrated.

In FIG. 9(a), the time series alignment unit 17 allocates data pieces associated with a time point/period included in or superimposed on each time point to each time point of the “set of time points” while allowing duplication. Here, the “time point” is a time point of a cycle in which arbitrary dimensional data/data representing a characteristic (in FIG. 9, data to be a focus for analysis) is completely allocated.

In FIG. 9(b), the time series alignment unit 17 selects the allocated data. As a result, as illustrated in FIG. 9(c), data processed such that there is a timing when the values of the data pieces change at the same time is obtained.

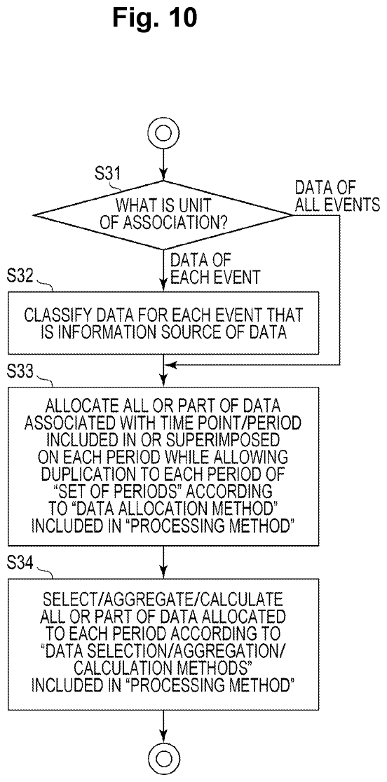

FIG. 10 is a flowchart illustrating a processing procedure of the time series alignment unit 17 when the processing type is “period”. In FIG. 10, the time series alignment unit 17 determines a unit of association (association) of data pieces at the same time point/in the same period (step S31), and if the unit is data having all events as an information source, the process proceeds to step S32. In step S31, if the unit of association is data in which each event is an information source, the time series alignment unit 17 classifies the data pieces for each event that is an information source of the data (step S32).

Next, the time series alignment unit 17 classifies associated time points/periods of data pieces at each time point of the “set of periods” for data of all events or data of each event (step S33). That is, the time series alignment unit 17 allocates, to each period, all or a part of data associated with a time point/period included in or superimposed on each period while allowing duplication.

Next, the time series alignment unit 17 selects/aggregates/calculates the data allocated to each period according to the “data selection/aggregation/calculation methods” included in the “processing method” (step S34). At this time, in a case where there is no dimensional data/data representing a characteristic allocated to a certain period, the period can be excluded from the “set of periods”. In addition, it is also possible to generate and accumulate a new multidimensional cube from each period and data obtained by selecting/aggregating/calculating all or a part of data allocated to each period.

According to the above procedure, the time series alignment unit 17 processes the data such that there is a timing at which the value of the data changes simultaneously according to the “set of periods” and the “processing method” as the processing conditions when the processing type is the “period”.

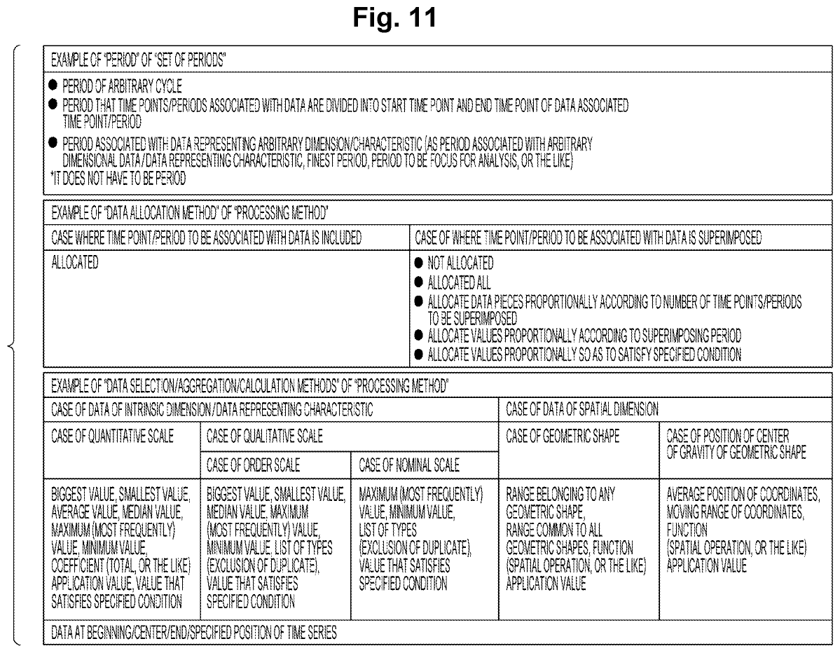

FIG. 11 is a diagram illustrating an example of “periods” in a “set of periods”, an example of a “data allocation method” in a “processing method”, and an example of “data selection/aggregation/calculation methods” of the “processing method” in FIG. 10.

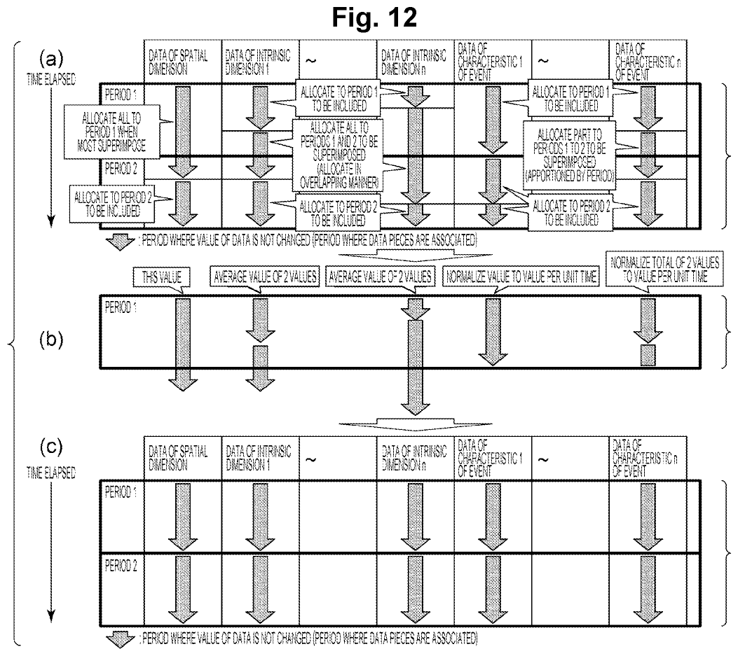

FIGS. 12 to 14 are schematic diagrams illustrating an example of a process of processing data such that there is a timing when values of the data pieces change at the same time. In FIG. 12, a period of an arbitrary cycle is illustrated as a “period” of a “set of periods”. In FIG. 12(a), the time series alignment unit 17 allocates all or a portion of data associated with a time point/period included in or superimposed on each period to each period of the “set of periods” while allowing duplication. Here, the “period” is a period of an arbitrary cycle.

In FIG. 7(b), the time series alignment unit 17 selects/aggregates/calculates the allocated data. As a result, as illustrated in FIG. 12(c), data processed such that there is a timing when the values of the data pieces change at the same time is obtained.

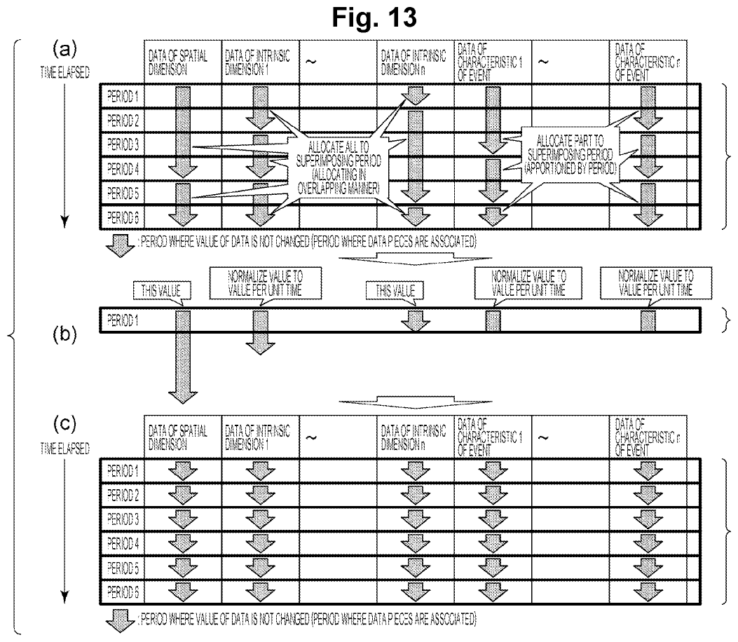

In FIG. 13, as a “period” of a “set of periods”, periods obtained by dividing a data associated time point/period at a start time point and an end time point of the data associated time point/period are illustrated.

In FIG. 13(a), the time series alignment unit 17 allocates all or a portion of data associated with a time point/period included in or superimposed on each period to each period of the “set of periods” while allowing duplication. Here, the “period” is a period obtained by dividing a time point/period associated with data at a start time point and an end time point of the time point/period associated with data.

In FIG. 13(b), the time series alignment unit 17 selects/aggregates/calculates the allocated data. As a result, as illustrated in FIG. 13(c), data processed such that there is a timing when the values of the data pieces change at the same time is obtained.

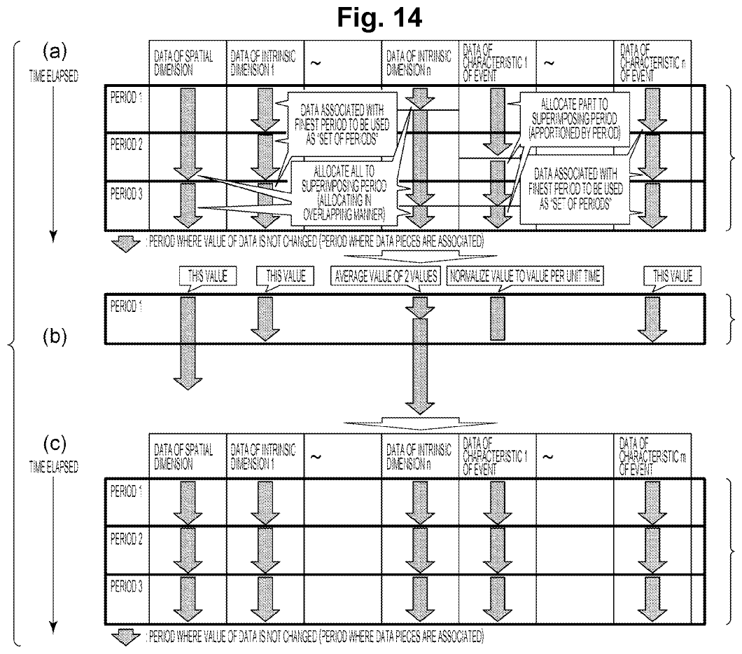

In FIG. 14, a period associated with arbitrary dimension data/data representing a characteristic is selected as the “period” of the “set of periods”. As a period associated with arbitrary dimensional data/data representing a characteristic, there are options such as a period with the finest granularity and a period to be a focus for analysis. FIG. 14 illustrates an example in which a period with the finest granularity is selected.

In FIG. 14(a), the time series alignment unit 17 allocates all or a portion of data associated with a time point/period included in or superimposed on each period to each period of the “set of periods” while allowing duplication. Here, the “period” is a period associated with arbitrary dimensional data/data representing a characteristic of the event. In FIG. 14, the finest period is illustrated.

In FIG. 14(b), the time series alignment unit 17 selects/aggregates/calculates the allocated data. As a result, as illustrated in FIG. 14(c), data processed such that there is a timing when the values of the data pieces change at the same time is obtained.

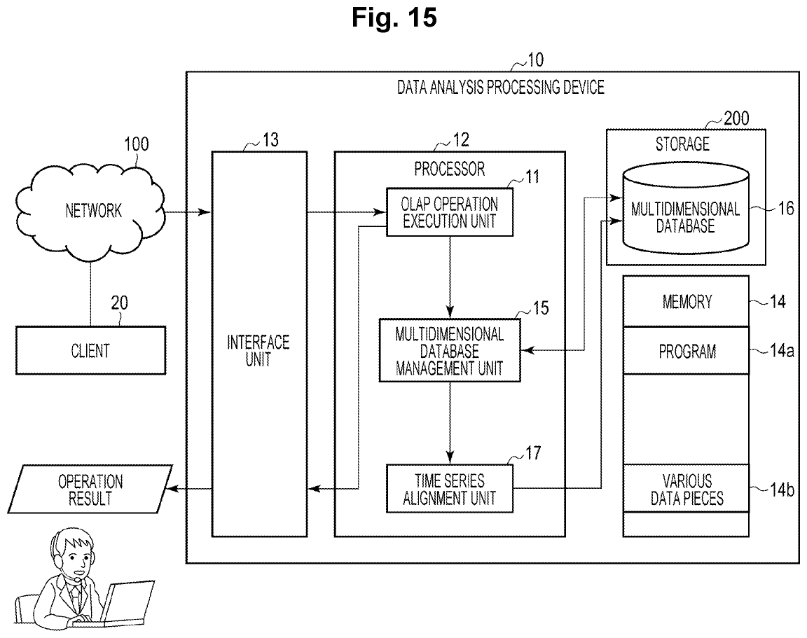

FIG. 15 is a block diagram illustrating an example of a hardware configuration of a data analysis processing device according to the present invention. In FIG. 15, the data analysis processing device 10 includes a processor 12, a storage 200 that stores the multidimensional database 16, an interface unit 13, and a memory 14. That is, the data analysis processing device 10 is a computer, and is realized as, for example, a personal computer, a server computer, or the like.

The interface unit 13 is connected to the network 100 and receives access from the client 20 connected to the network 100.

The storage 200 is, for example, a non-volatile storage medium (block device) such as a hard disk drive (HDD) or a solid state drive (SSD). The storage 200 stores the multidimensional database 16 in addition to a basic program such as an operating system (OS) or a device driver, a program for realizing the function of the data analysis processing device 10, and the like.

The memory 14 in FIG. 15 is, for example, a random access memory (RAM), and stores a program 14a loaded from the storage 200 and various data pieces 14b.

Moreover, the processor 12 in FIG. 15 is an arithmetic unit such as a central processing unit (CPU) or a micro processing unit (MPU), and implements the functions thereof by the program loaded in the memory 14.

Meanwhile, the processor 12 includes an OLAP operation execution unit 11, a multidimensional database management unit 15, and a time series alignment unit 17 as processing functions according to the embodiment. The OLAP operation execution unit 11, the multidimensional database management unit 15, and the time series alignment unit 17 are processing functions implemented by the processor 12 executing instructions included in a program 14a. That is, the data analysis processing device 10 of the present invention can also be realized by a computer and a program. In addition to recording and distributing the program on a recording medium such as an optical medium, it is also possible to provide the program through the network.

Note that the OLAP operation execution unit 11, the multidimensional database management unit 15, and the time series alignment unit 17 may be realized in other various forms including an integrated circuit such as an application specific integrated circuit (ASIC) or a field-programmable gate array (FPGA) instead of or in addition to the processor 12.

The processor 12 can receive the OLAP operation and arguments from the client 20 via the interface unit 13, and can transmit an operation result to the client 20.

(Effects)

In a case where there is no timing when the values of the dimensional data to be analyzed/data representing a characteristic change at the same time, the data analysis processing device 10 allocates data associated with a time point/period included in or superimposed on each time point to each time point of the “set of time points” for all the data pieces of events or each data of events while allowing duplication, and selects data allocated to each time point. Alternatively, the data analysis processing device 10 allocates all or a part of data associated with a time point/period included or superimposed in or on each period to each period of the “set of periods” while allowing duplication, and selects/aggregates/calculates the data allocated to each period. In this manner, the data analysis processing device 10 processes the data such that there is a timing when the values of the data pieces to be analyzed change at the same time.

As described above, in a case where there is no timing when the values of the dimensional data to be analyzed/data of the characteristic of the event change at the same time, the data is processed such that there is a timing when the values of the data pieces change at the same time, whereby the data of the same time point/the same period can be associated.

Therefore, according to the embodiment, even when there is no timing at which the value of the data of the dimension to be analyzed/the value of the data of the characteristic of the event change at the same times, it is possible to analyze the data pieces of the same time point/the same period in association with each other. As a result, according to the embodiment, it is possible to provide a data analysis processing device, a data analysis processing method, and a program capable of relaxing restrictions on analysis and analyzing data at the same time point or in the same period in association with each other.

That is, the present invention is not limited to the embodiments stated above, and the constituent elements can be modified and implemented without departing from the gist of the invention. Various inventions can be formed by appropriately combining a plurality of the constituent elements disclosed in the embodiments stated above. For example, some constituent elements may be omitted out of all the constituent elements described in the embodiments. Moreover, the constituent elements in the different embodiments may be appropriately combined.

### REFERENCE SIGNS LIST

10 Data analysis processing device
11 OLAP operation execution unit
12 Processor
13 Interface unit
14 Memory
14a Program
14b Various data pieces
15 Multidimensional database management unit
16 Multidimensional database
17 Time series alignment unit
20 Client
100 Network
200 Storage

1. A data analysis processing device comprising:
a multidimensional database for accumulating data pieces embodying a real-world event in a multidimensional cube constructed for each subject in association with an identifier of the event;
an online analytical processing (OLAP) operation execution unit, including one or more processors, configured to execute an OLAP operation on the multidimensional cube in response to a request from a client;
a multidimensional database management unit, including one or more processors, configured to manage data of a time dimension, data of a spatial dimension, data of a plurality of types of intrinsic dimensions, and data representing characteristics of a plurality of types in the multidimensional cube; and
a time series alignment unit, including one or more processors, configured to process data such that a timing at which a value of dimensional data to be analyzed and/or a value of data representing a characteristic to be analyzed change at the same time exists in a case where the timing does not exist.

2. The data analysis processing device according to claim 1, wherein the OLAP operation execution unit is configured to use at least one of an argument an instruction on which is given from the client, data configuring another of the multidimensional cube, and the processed data as an argument of the OLAP operation.

3. The data analysis processing device according to claim 1, wherein the time series alignment unit is configured to:
(i) classify time points/periods associated with dimensional data to be analyzed/data representing a characteristic to be analyzed for each event at each time point of a set of time points, and
(ii) process the data such that there is a time when the values change at the same time by allocating the data included in or superimposed at each time point or associated with a time point/period to each of time points while allowing duplication.

4. The data analysis processing device according to claim 1, wherein the time series alignment unit is configured to:
classify time points/periods associated with dimensional data to be analyzed/data representing a characteristic to be analyzed for each event at each time point of a set of time points,
allocate, to each of the periods, at least a part of data associated with a time point/period included in or superimposed on each of the periods while allowing duplication, and
process data such that there is a time when values change at the same time by selecting/aggregating/calculating the data allocated to each of the periods.

5. A data analysis processing method comprising:
accumulating data pieces embodying a real-world event in a multidimensional cube constructed for each subject in association with an identifier of the event in a multidimensional database;
executing an online analytical processing (OLAP) operation on the multidimensional cube in response to a request from a client;
managing data of a time dimension, data of a spatial dimension, data of a plurality of types of intrinsic dimensions, and data representing characteristics of a plurality of types in the multidimensional cube; and
processing data such that a timing when a value of dimensional data to be analyzed and/or a value of data representing a characteristic to be analyzed change at the same time exists in a case where the timing does not exist.

6. A non-transitory computer-readable medium storing software comprising instructions executable by one or more computers which, upon such execution, cause the one or more computers to perform operations comprising:
accumulating data pieces embodying a real-world event in a multidimensional cube constructed for each subject in association with an identifier of the event in a multidimensional database;
executing an online analytical processing (OLAP) operation on the multidimensional cube in response to a request from a client;
managing data of a time dimension, data of a spatial dimension, data of a plurality of types of intrinsic dimensions, and data representing characteristics of a plurality of types in the multidimensional cube; and
processing data such that a timing when a value of dimensional data to be analyzed and/or a value of data representing a characteristic to be analyzed change at the same time exists in a case where the timing does not exist.

7. The data analysis processing method according to claim 5, further comprising:
using at least one of an argument an instruction on which is given from the client, data configuring another of the multidimensional cube, and the processed data as an argument of the OLAP operation.

8. The data analysis processing method according to claim 5, further comprising:
classifying time points/periods associated with dimensional data to be analyzed/data representing a characteristic to be analyzed for each event at each time point of a set of time points; and
processing the data such that there is a time when the values change at the same time by allocating the data included in or superimposed at each time point or associated with a time point/period to each of time points while allowing duplication.

9. The data analysis processing method according to claim 5, further comprising:
classifying time points/periods associated with dimensional data to be analyzed/data representing a characteristic to be analyzed for each event at each time point of a set of time points;
allocation, to each of the periods, at least a part of data associated with a time point/period included in or superimposed on each of the periods while allowing duplication, and
processing data such that there is a time when values change at the same time by selecting/aggregating/calculating the data allocated to each of the periods.

10. The non-transitory computer-readable medium according to claim 6, further comprising:
using at least one of an argument an instruction on which is given from the client, data configuring another of the multidimensional cube, and the processed data as an argument of the OLAP operation.

11. The non-transitory computer-readable medium according to claim 6, further comprising:
classifying time points/periods associated with dimensional data to be analyzed/data representing a characteristic to be analyzed for each event at each time point of a set of time points; and
processing the data such that there is a time when the values change at the same time by allocating the data included in or superimposed at each time point or associated with a time point/period to each of time points while allowing duplication.

12. The non-transitory computer-readable medium according to claim 6, further comprising:
classifying time points/periods associated with dimensional data to be analyzed/data representing a characteristic to be analyzed for each event at each time point of a set of time points;
allocation, to each of the periods, at least a part of data associated with a time point/period included in or superimposed on each of the periods while allowing duplication, and
processing data such that there is a time when values change at the same time by selecting/aggregating/calculating the data allocated to each of the periods.
